(19) United States
(12) Patent Application Publication
(10) Pub. No.: US 2012/0112105 A1
(43) Pub. Date: May 10, 2012

(54) HIGH PRESSURE CONTROL VALVE

(75) Inventors: Harald Burkart, Villingen-Schwenningen (DE); Wolfram Maiwald, Villingen-Schwenningen (DE); Rolf Hermann, Konigsfeld (DE); Frank Zelano, St. Georgen (DE); Ralf Heingl, Villingen-Schwenningen (DE); Klaus Schiess, Allensbach (DE)

(73) Assignee: KENDRION Binder Magnete GmbH

(21) Appl. No.: 13/275,488

(22) Filed: Oct. 18, 2011

(30) Foreign Application Priority Data
Oct. 21, 2010 (DE) 10 2010 049 035.0

(51) Int. Cl. F16K 31/02

(52) U.S. Cl. 251/129.15

(57) ABSTRACT

High-pressure regulating valve (1) with a valve body (2) with an inlet (20) and an outlet (21), a sealing element (4), which acts on a valve seat (3), which is disposed on the valve body (2) between inlet (20) and outlet (21) and has a valve bore (30), an activating element (5) that is mounted able to move along a longitudinal axis and can be activated by an appropriately configured electromagnet (6), wherein an armature (62) of the electromagnet (6) and the activating element (5) are configured as nonconnected, separate structural elements.

The present invention concerns a high-pressure regulating valve according to the preamble of patent claim 1.

Such high-pressure regulating valves are familiar from the prior art, e.g., for pressure regulation in common-rail motors.

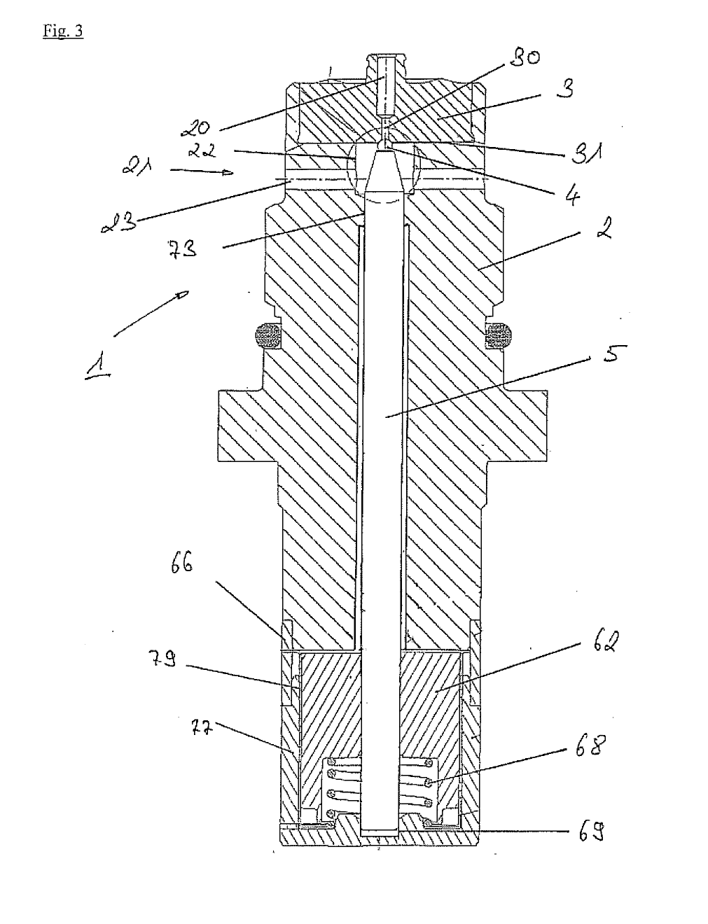

The high-pressure regulating of fluids occurs generally by means of ball-seat valves. These are as a rule electromagnetically actuated. Electromagnetically operated high-pressure regulating valves of the prior art are generally built as follows, an example is depicted in FIG. 3.

The high-pressure regulating valve 1 has a valve body 2 with an inlet 20 and an outlet 21, in which pressures up to 2400 bar can occur at present at the inlet side or in the area of application of the common-rail motors. Between the inlet 20 and the outlet 21 there is disposed a valve seat 3, through which passes a valve bore 30, connecting the inlet 20 and outlet 21. The valve bore 30 can be sealed off at the outlet end by a sealing means 4, which is generally designed as a sealing ball. The sealing ball 4 can be pressed against the valve seat 3 by a valve pin 5 for this purpose. On account of the increased loads acting on the sealing ball 4, the valve seat 3 is made of hardened steel. For cost considerations, the rest of the valve body 2 is made of unhardened steel.

The outlet 21 is formed by radial bores 23 at the outlet side of the valve body 2. To achieve the most compact possible form of the valve 1, the radial bores 23 are disposed as closely as possible beneath the valve seat 3. Thanks to this design, a shoulder 22 is formed between the valve seat 3 and the outlet bores 23 that transfers the necessary forces for a clamping of the valve seat 3 during installation of the valve 1.

The valve pin 5 can be moved along its longitudinal axis by an electromagnetic drive unit 6, disposed at the outlet end. The drive unit 6 is generally constructed from a coil 61 through which current can be passed, disposed on a coil holder 60, and an armature 62 that can be actuated by a generated magnetic field. The armature 62 and the valve pin 5 are welded or press-fitted together and thus permanently joined to each other. The armature 62, furthermore, is biased by a compression spring 68 in the closing direction of the valve 1, so that the valve 1 is closed when no current is passing through the coil 61.

The armature 62 and the compression spring 68 are mounted at the rear in a bushing 77, which is fastened to the valve body 2 or by a welded ring 66. The valve pin 5 is held in the bushing 77, centered relative to the bushing 77, by a bearing bush 69. The valve pin 5 is taken up in a lengthwise bore of the valve body 2.

It is centered in this lengthwise bore at the front end by a bearing 73, formed by an encircling projection of the valve body 2. All parts of the bearing need to be fabricated with high precision and flush with the opening of the valve bore 30 at the outlet end, which is to be considered another bearing. Due to the consecutive placement of 3 bearings in a row, the mechanical system of armature 62, valve pin 5, valve body 2 and valve seat 3 is statically overdetermined, so that as soon as alignment is lost radial forces appear on the sealing ball 4, resulting in leakage of the valve 1 or a jamming of the valve pin 5 or the armature 62.

Other high-pressure regulating valves 1 known from the prior art have, e.g., an asymmetrical armature 62, which already by virtue of its geometry introduces a tilting moment into the system of armature 62 and valve pin 5. Thus, in this known valve, problems can occur even with a precise bearing, such as a jamming of the armature 62 or the valve pin 5.

Furthermore, high-pressure regulating valves 1 are known in which a bearing of the permanently joined system of armature 62 and valve pin 5 occurs exclusively by a guidance of the valve pin 5 in a lengthwise bore of the valve body 2. In this known valve 1, tilting moments can be introduced by an asymmetrical force acting on the armature 62, such as when armature and valve pin 5 are not orthogonal to each other, which then act on the valve pin 5. Furthermore, it is not possible to have a precise bearing of the armature 62 and thereby accomplish a dampening of the system.

The problem of the present invention is to provide a high-pressure regulating valve that does not have the above-mentioned problems.

This problem is solved by a high-pressure regulating valve with the features of patent claim 1. Advantageous modifications are the subject of subclaims.

A high-pressure regulating valve according to the invention has a valve body with an inlet and an outlet, wherein a sealing element acts on a valve seat, which is disposed on the valve body between inlet and outlet and has a valve bore. An activating element is provided that is mounted able to move along its longitudinal axis and can be activated by an appropriately configured electromagnet. According to the invention, an armature of the electromagnet and the activating element are configured as nonconnected, separate structural elements.

Thanks to such a configuration, a decoupling is accomplished between activating element and electromagnet, so that manufacturing errors in the area of the electromagnet or in the connection region between electromagnet and valve body are not passed on to the activating element. Furthermore, a highly precise alignment is only needed between a bearing of the activating element and the valve bore, so that in particular the alignment between the armature and the valve body can have increased tolerances. Since the valve seat with the valve bore, as well as a lengthwise bore in the valve body that serves as a sliding bearing for the activating element, are fabricated in a single work step, this system can be fabricated with slight tolerances, so that even with static overdetermination of the system no negative effects are to be anticipated.

An especially simple bearing for the activating element can be achieved in a lengthwise bore of the valve body when the activating element is configured as a valve pin.

When the armature and the activating element are configured as nonconnected separate parts, it is furthermore possible to mount the armature and the activating element in separate bearings. In this way, on the one hand, the armature can be mounted in a bushing with high precision and dampening, for example, and at the same time the activating element or the valve pin is mounted precisely in relation to the valve seat and the valve bore. Deviations or manufacturing tolerances located in the connection of the bushing to the valve body are in this way not passed on to the sealing element or the valve seat, so that an improved reliability and tightness of the valve is achieved.

The valve pin is preferably mounted in a lengthwise bore of the valve body that is configured as a sliding bearing, so that in particular radial deviations in relation to the bore situated in the valve seat are avoided.

In this way, furthermore, it is possible to mount the armature in a bushing configured as a sliding bearing, and at the same time it can be configured such that a dampening of the armature is possible. In this way, pressure surges acting on the activating element in the direction of the armature can be dampened in the armature bushing, thereby avoiding a buildup in the system.

The invention will be explained more closely below with reference to the enclosed figures.

There are shown:

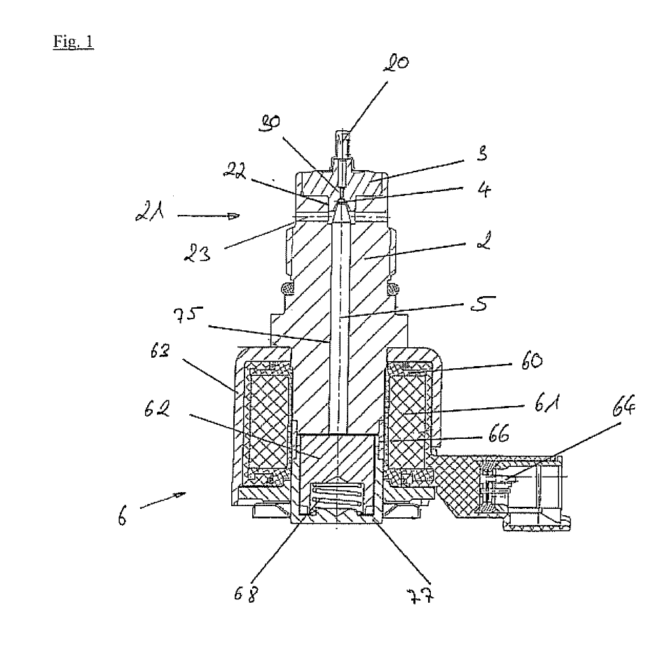

FIG. 1, a cross section of a high-pressure regulating valve according to the invention,

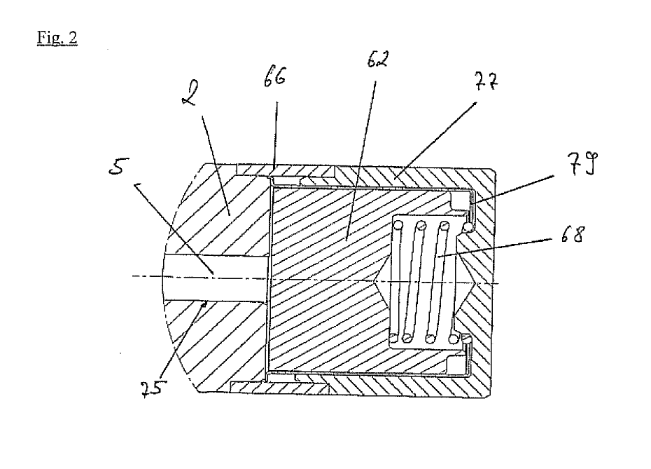

FIG. 2, an enlarged view of the intersection between armature and valve pin of the valve from FIG. 1, and

FIG. 3, a cross sectional view of a high-pressure regulating valve according to the prior art (already discussed).

FIG. 1 shows a cross section through a high-pressure regulating valve 1 according to the invention. The high-pressure regulating valve 1 is essentially constructed from a valve body 2 that is rotationally symmetrical about a lengthwise axis, with an inlet 20 and an outlet 21. Between the inlet 20 and the outlet 21, a valve seat 3 of hardened steel is pressed into the valve body 2, having a valve bore 30 that connects the inlet 20 to the outlet 21. The outlet 21 in the present example is formed by radially running bores 23 in the valve body 2.

One end of the valve bore 30 at the outlet side can be closed by a sealing means 4, which is the present example is formed as a sealing ball. A closing force is transmitted to the sealing ball 4 by an activating element 5, which in the present example is configured as a valve pin, from an activating unit 6 disposed on the valve body 2 at the rear end, being configured as an electromagnet in the present example. The valve pin 5 is taken up and mounted in a bore running along the lengthwise axis of the valve body 2 and configured as a sliding bearing 75. A length of the valve pin 5 is dimensioned such that it protrudes at the back end into a bushing 77, in which an armature 62 of the electromagnet 68 is mounted. The bushing 77 is connected to the valve body 2 all around by means of a welded ring 66. Furthermore, the armature 62 is stressed by the spring force of a compression spring 68 in the closing direction of the valve, so that the valve 1 is closed up to a certain pressure dictated by the spring force of the compression spring 68 when there is no current passing through the electromagnet 6.

The electromagnet 6 for activation of the armature 62 is formed from a coil 61 surrounding the valve body 2 and the bushing 77, arranged on a coil holder 60. The coil holder 60 and the coil 61 are taken up together in a housing 63, which is connected to the valve body 2. If the pressure of a fluid occurring at the inlet side exceeds the maximum pressure dictated by the spring force of the compression spring 68, it is necessary to pass additional current through the coil 61 for the magnetic force to support the spring force and hold the valve 1 closed. Current can pass through the coil by contacts 64 led in laterally from the outside.

During the fabrication of the high-pressure regulating valve I, the valve body 2 with the sliding bearing 75 and the valve seat 3 with the valve bore 30 are generally fabricated in a single work step, so that these parts can be made in high precision alignment and with very slight manufacturing tolerances. A valve pin 5 taken up in the sliding bearing 75 can thus be mounted very precisely in relation to the valve bore, so that a radially offset force component on the sealing ball 4 for closing the high-pressure regulating valve 1 can be practically ruled out.

FIG. 2 shows in an enlargement the accommodation of the armature 62 in the bushing 77, as well as the intersection with the valve pin 5 taken up in the sliding bearing 75. The representation in FIG. 2 is turned by 90 degrees counterclockwise in comparison to FIG. 1.

In this representation, it is especially obvious that the armature 62 is mounted in the bushing 77 by an additional bearing sleeve 79. Such a mounting of the armature 62 is only possible by the decoupling between the armature 62 and the valve pin 5, for otherwise angle discrepancies between the bushing 77 and the valve body 2 as might occur by welding to the welding ring 66 would be transmitted to the valve pin 5. It is furthermore possible to adjust a dampening of the bearing 62 by the bearing sleeve 79, so that oscillations of the entire system which could be transmitted to the fluid circulation are reduced.

### LIST OF REFERENCE SYMBOLS

1 high-pressure regulating valve

2 valve body

3 valve seat

4 sealing element

5 activating element

6 activating device

20 inlet

21 outlet

22 shoulder

23 opening/bore

30 valve bore

60 coil holder

61 coil

62 armature

63 housing

64 contacts

66 welding

68 compression spring

69 bearing bush

71 bearing

73 bearing

75 sliding bearing

77 bushing

79 bearing sleeve

1.-8. (canceled)

9. A high pressure regulating valve system, comprising:
a valve body having an operative inlet and an operative outlet;
a sealing element operative on a valve seat;
said valve seat disposed on said valve body between said inlet and said outlet;
said sealing element operative with a valve bore and an activating element operatively mountable for movement along a motion axis and operatively engagable with a configured electromagnet;
an armature in said electromagnet; and
said armature and said activating element being configured as nonconnected and operatively separable structural elements in said high pressure regulating valve system.

10. A high pressure regulating valve system, according to claim 9, wherein:
said activating element is operably configured as a valve pin.

11. A high pressure regulating valve system, according to claim 10, further comprising:
a mount for said activating element;
a mount for said armature; and
said mount for said activating element being different from said mount for said armature.

12. A high pressure regulating valve system, according to claim 11, wherein:
said valve pin is slidably mounted in a lengthwise bore of said valve body; and
said valve body is operatively configured as a sliding bearing during an operation of said high pressure regulating valve system.

13. A high pressure regulating valve system, according to claim 12, wherein:
said armature is mounted in a bushing operably configured with a sliding bearing.

14. A high pressure regulating valve assembly, according to claim 13, wherein:
said sliding bearing is operably configured for a dampening of the armature.

15. A high pressure regulating valve assembly, comprising:
a valve body having an operative inlet and an operative outlet;
a sealing element operative on a valve seat;
said valve seat disposed on said valve body between said inlet and said outlet;
said sealing element operative with a valve bore and an activating element operatively mountable for movement along a motion axis and operatively engagable with a configured electromagnet;
an armature in said electromagnet;
said armature and said activating element being configured as nonconnected and operatively separable structural elements in said high pressure regulating valve system;
said activating element is operably configured as a valve pin;
a mount for said activating element;
a mount for said armature; and
said mount for said activating element being different from said mount for said armature.

16. A high pressure regulating valve system, according to claim 15, wherein:
said valve pin is slidably mounted in a lengthwise bore of said valve body;
said valve body is operatively configured as a sliding bearing during an operation of said high pressure regulating valve system;
said armature is mounted in a bushing operably configured with a sliding bearing; and
said sliding bearing is operably configured for a dampening of the armature.
